(19) United States
(12) Patent Application Publication
(10) Pub. No.: US 2004/0017563 A1
(43) Pub. Date: Jan. 29, 2004

(54) Method and apparatus for volume and density measurements

(76) Inventors: Lawrence H. James, Raleigh, NC (US); Ali Regimand, Raleigh, NC (US); Peter D. Muse, Durham, NC (US); Tianqing He, Cary, NC (US)

Correspondence Address: MYERS BIGEL SIBLEY & SAJOVEC, PO BOX 37428, RALEIGH, NC, 27627, US

(21) Appl. No.: 10/452,338

(22) Filed: Jun. 2, 2003

Related U.S. Application Data
(60) Provisional application No. 60/398,618, filed on Jul. 25, 2002.

(51) Int. Cl. G01N 21/01

(52) U.S. Cl. 356/244

(57) ABSTRACT

Apparatus, methods, systems and computer program products measure at least one predetermined characteristic of an object including at least one of a surface profile, volume, and/or density of an object. The apparatus includes a support assembly for holding an object in position. A displacement measurement transducer is situated a predetermined distance from the support assembly and is configured to measure a point position on the object. At least one of the sample support assembly or the displacement measurement transducer may be moved such that the displacement measurement transducer measures a plurality of point positions on the object.

### RELATED APPLICATIONS

This application claims priority to U.S. patent application Ser. No. 60/398,618 filed Jul. 25, 2002, the disclosure of which is incorporated herein by reference in its entirety.

### FIELD OF THE INVENTION

The present invention is related to methods and apparatus for measuring volume and/or the weight of material samples and for calculating the density.

### BACKGROUND OF THE INVENTION

Measuring the density of an object may be difficult, particularly if the object is of an irregular shape. In order to determine the density of a material sample, the volume must be measured. For example, one measurement of quality for materials such as asphalt and other construction materials is a density measurement, which is the ratio of mass to volume. Measuring the volume is therefore important to ensure that a material meets a particular density standard.

The volume of a regularly shaped object may be measured using a relatively small number of dimensional measurements. For a regularly shaped object, irregularities are generally small in comparison to the overall dimensions of the object, and therefore, it is practical to measure the small number of measurements needed using a dimensional measurement tool such as a ruler or, for increased accuracy, calipers. The volume of the object may be calculated using standard formulas corresponding to the sample shape of the object for volume calculation. For example, there are known mathematical equations that can be used with physically measured dimensions to yield volumes of cubes, spheres, cylinders and other standard shapes. However, more complicated shapes and irregular objects can require a large number of dimensional measurements, and such measurements may be difficult to make accurately, particularly over an irregular or coarse outer surface.

One method for measuring the volume of irregular solid objects is by using water displacement methods. For example, the difference between the weight of an object in air and in water is equal to the weight of the water displaced. The density of water (the ratio of mass to volume) is a known value. Thus, the volume of the water displaced may be calculated. Alternatively, the displaced water may be measured by measuring the volume of a water sample before and after an object is placed in the water sample. Both methods have the disadvantage of requiring submersion of the object being measured. Samples may be sealed in a water impermeable covering of sealant material to avoid water contamination.

A need remains to provide methods and systems for measuring the volume of regular and irregular objects without requiring submersion and/or sealing a sample in a sealant material, for example, such that the material sample density may be calculated.

### SUMMARY OF THE INVENTION

Embodiments according to the present invention provide apparatus, methods and systems for measuring the dimensions of the object, measuring the mass of the object, calculating the volume from the measured dimensions, and/or calculating the density of an object. In certain embodiments, an apparatus includes a support assembly for holding the object in position during evaluation. In operation, a displacement measurement transducer (DMT) is situated a predetermined distance from the support assembly and is configured to measure a point position on the object. A means for moving at least one of the support assembly or the DMT is also provided such that the DMT measures a plurality of points on the object. In certain embodiments, the means for moving is a linear motion mechanism connected to the DMT for moving the DMT with respect to the object.

### BRIEF DESCRIPTION OF THE DRAWINGS

FIG. 1a is a top view of a cross section of a sample object having a cylindrical shape.

FIG. 1b is a perspective side view of a sample object having a cylindrical shape and a constant height.

FIG. 1c is a cross sectional side view of a substantially cylindrical sample object having a circular shaped midsection such as the cross section shown in FIG. 1a and an irregular height.

FIG. 2a is a front view of a volume measurement assembly device according to embodiments of the present invention.

FIG. 2b is side view of the device shown in FIG. 2a.

FIG. 3 is side view of the device shown in FIG. 2a illustrating that the sample may be pulled out of the device and/or rotated according to embodiments of the present invention.

FIG. 4a is a front side view of a linear motion mechanism according to embodiments of the present invention.

FIG. 4b is a right side view of the device shown in FIG. 4a according to embodiments of the present invention.

FIG. 4c is a top view the device shown in FIG. 4a according to embodiments of the present invention.

FIG. 5 is side view of a volume measurement assembly with the sidewall of the housing removed according to embodiments of the present invention.

FIG. 6 is side view of an alternate volume measurement assembly according to embodiments of the present invention.

FIG. 7 is a side view of another alternate volume measurement assembly according to embodiments of the present invention.

FIG. 8 is a flowchart illustrating operations according to embodiments of the present invention.

### DESCRIPTION OF EMBODIMENTS OF THE INVENTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, components, features, or regions may be exaggerated for clarity.

The present invention provides methods, apparatuses, systems and computer program products for measuring the volume and/or density of a sample object. More specifically, the invention may be particularly suitable for use with material specimens which exhibit irregular or coarse exterior surfaces and porosity or voids, such as samples of uncompacted, loose, or compacted bituminous mixtures, soil samples, aggregates, and concrete specimens used in the structure, infrastructure, and/or underlayment of many roadways and other composite compacted materials. A typical method used to obtain a field sample of a compacted bituminous (asphalt) mixture involves taking pavement specimens from pavements in the field with a core drill, diamond or a carborundum saw, and the like. In any event, the asphalt specimen, whether from the field or molded in the laboratory, is typically in the shape of a cylinder. Field specimens typically exhibit a rough uneven exterior surface.

In some embodiments, the measured dimensions and mass may be used to calculate volume and/or density of a sample material.

In certain embodiments, a support assembly holds the object to be measured in position. A displacement measurement transducer (“DMT”) is situated a desired distance from the support assembly. Suitable DMT devices are commercially available, for example, from Micro-Epsilon, Raleigh, N.C. The DMT is configured to measure successive external point positions on the object. For example, the DMT may measure the distance between the DMT and the object surface. The apparatus includes a mechanism for moving at least one of the support assembly or the DMT such that the DMT may measure a plurality of point positions on the object.

### Calculation Example

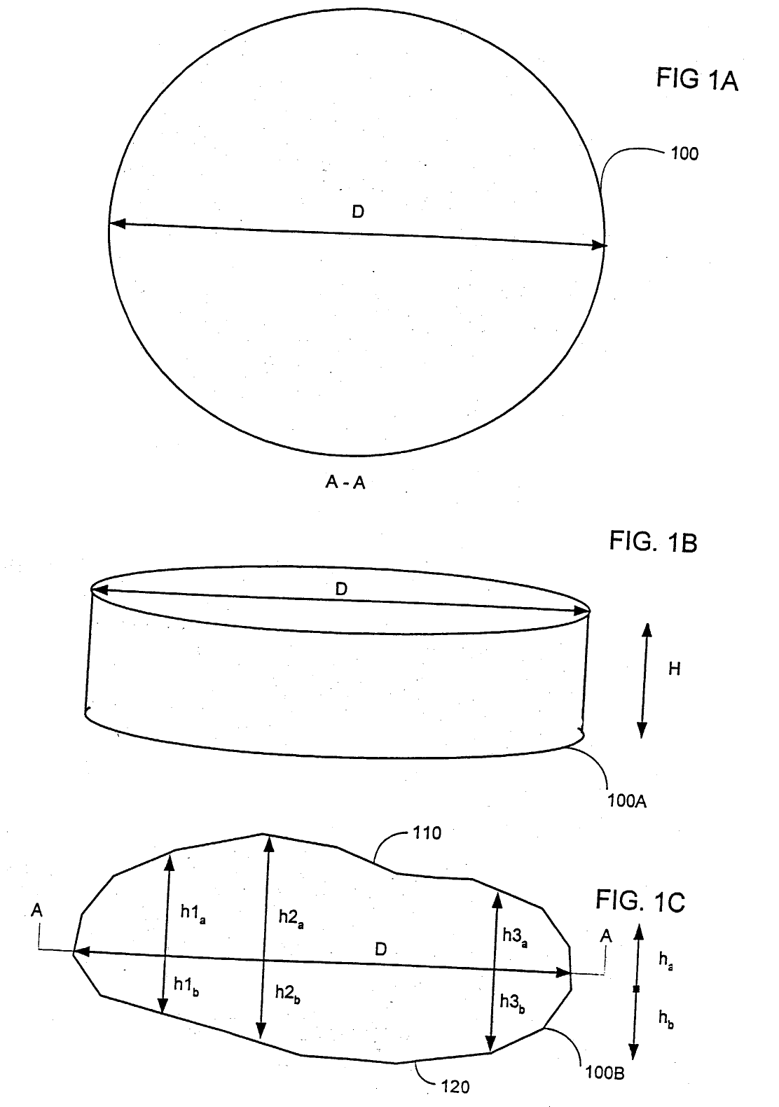

To obtain an accurate representation of the surface profile of an object, the average dimensions of the object may be used to calculate the volume of an object according to formula and calculations known to those of ordinary skill in the art. For example, the volume of a regularly shaped cylinder may be calculated by measuring the diameter of the circular base and the height. As used herein, a surface profile includes measurements of thickness, height, and/or diameter. Similarly, the calculation of an irregularly shaped cylinder may be performed using an analogous, modified formula. As used herein, a cylinder is any object having a substantially circular cross section through at least one plane along its width and a regular or irregular thickness. Examples of irregular shaped objects include an irregularly shaped cylinder, rectangle, square, oval, disk or any object having at least one of a rough surface, any variation in dimensions, a shape having a thickness that varies by more than about 5% of the average thickness, or a shape requiring more than about three measurements of dimension to calculate a substantially accurate estimated volume to give repeatable volume measurements within about ±1.0%, and typically within ±0.5%. FIG. 1b illustrates a cylinder 100A having a constant height H (thickness) and a diameter D (width). FIG. 1b has a circular cross section such as the top view of the cross section having a diameter D depicted in FIG. 1a. Another example of an object that has a circular cross section such as the cross section depicted in object 100 in FIG. 1a is an irregularly shaped cylinder. FIG. 1c is an example of a side view of such an irregularly shaped cylinder 100B which also has a circular top view cross section across a width with diameter D such as that shown as object 100 in FIG. 1a through a cross sectional width A-A. In contrast to cylinder 100A in FIG. 1b, cylinder 100B has a variable height over the length of diameter D. Each height measurement has a top height component hₐ along a first surface 110 and a bottom height component h_{b} along a second surface 120. FIG. 1c illustrates three point measurements of height: h1ₐ, h1_{b}, h2ₐ h2_{b}, h3ₐ, h3_{b}. The average thickness (T) of the sample object is the sum of the average height in the hₐ direction and the average height in the h_{b} direction.

For irregular shaped objects, such as that shown in FIG. 1c, the average thickness may be calculated in a number of ways. For example, measurements of variable height in the hₐ and h_{b} directions may be made at points selected at a substantially constant concentration, that is, at a substantially equal distance from one another along the first surface 110 and the opposing second surface 120. The approximate average thickness (T) may be calculated using Equation 1 below:

$$T = \frac{1}{N} {\sum }_{i = 1}^{N} {h}_{ia} + \frac{1}{{N}^{′}} {\sum }_{j = 1}^{{N}^{′}} {h}_{jb} \qquad ( 1 )$$

where T is the average thickness, and N is the number of measurements taken over the first surface 110 and N′ is the number of measurements taken over the second surface 120. The accuracy of the calculation can be increased with increasing numbers of measurements. The measurements may be taken along corresponding pairs of upper and lower measurements. Alternatively, the points measured on the first surface 110 do not necessarily need to correspond to the points measured on the second surface 120. In addition, the number of points N measured on the first-surface 110 may or may not be equal to the number of points N′ measured on the second surface 120.

Other methods known to those of ordinary skill in the art for calculating the average thickness on one or more sides may be used. For example, a plurality of point measurements may be made in the hₐ and h_{b} directions along the first surface 110 and the second surface 120 at the same or equal distances from one another. Extrapolations may be made according to methods known to those of ordinary skill in the art to approximate the shape of the first surface 110 and the second surface 120 to obtain an average thickness.

The volume may be calculated using Equation 2 below:

$$V = {π ( \frac{1}{2} D )}^{2} T \qquad ( 2 )$$

where V is the volume, D is the diameter, and T is the average thickness.

The above calculations require a calculation of the average thickness (T) a known or measured diameter (D) of the circular cross section. As would be understood by one of ordinary skill in the art, similar calculations may be performed using cross sections of alternative shapes such as ellipses, squares, rectangles, hexagons, pentagons, and other regular shapes. Objects that do not have a regularly shaped cross sectional width such as the circular cross sectional width depicted in FIG. 1a above may require that measurements similar to the average thickness measurements described above, made with respect to the width and/or the length of the object in addition to the height. When sufficient dimensional measurements are known, the volume may be more reliably calculated. Various formulas may be used to calculate volume. The number of dimensional measurements necessary to calculate the volume depends on the degree of accuracy desired and the shape of the object.

### Example Embodiments

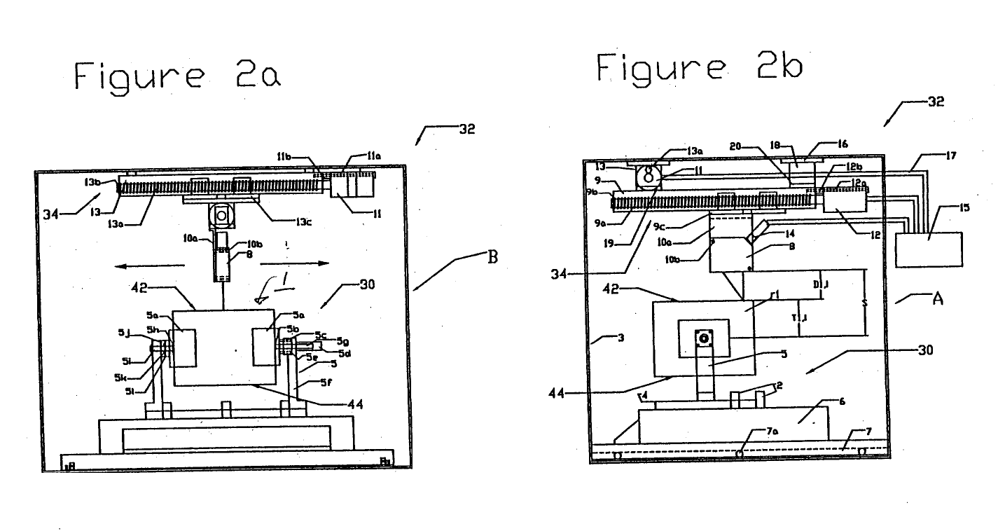

In overview, embodiments of the present invention employ a device such as a displacement measurement transducer (“DMT”) to obtain a plurality of thickness and/or height measurements. The thickness measurements may be used to calculate the volume of a sample according to the equations above or according to other equations known to those of ordinary skill in the art. Other suitable measurement device can be employed as known to those of skill in the art. However, for ease of discussion, the measurement device described below will be a DMT. Other suitable devices include non-contact or contact measuring devices such as an ultra sound or nuclear source and detector configurations for measuring the dimensions at a point on a sample may be substituted for a DMT. As would be understood by those of skill in the art, scattering from a nuclear source may also be used to calculate the density once the thickness and/or dimensions have been measured. That is, a properly calibrated device can use scattering from a nuclear source to calculated the density from known dimensions without requiring a measurement of the weight of the object. The embodiments described with reference to FIGS. 2a and 2b can be used to obtain dimensional and/or weight measurements using automated mechanical elements without requiring manual intervention by an operator.

FIG. 2a is front view and FIG. 2b is a side view of embodiments of the present invention. The apparatus 32 can be positioned in a housing with upwardly extending sidewalls and a ceiling and floor. For clarity, one of the sidewalls has not been shown. The apparatus 32 includes a support assembly 30 having a support clamp assembly 5 for holding a three dimensional sample 1, which has a top surface 42 and a bottom surface 44. For clarity and ease of representation, the sample 1 is depicted as having a rectangular or cylindrical shape. However, any regular or irregular sample shape and size may be used. The support clamp 5 is situated on a support base 4, which is placed on a scale 6. The scale 6 may be calibrated to measure the mass (weight) of the sample 1. The scale 6 may be configured to measure the mass (weight) of the sample 1 without requiring additional movement. For example, the scale 6 may be placed underneath the sample 1 and the support assembly 30 and calibrated to subtract the weight of the support assembly 30 from the total weight of the assembly and the sample 1 in order to measure the weight of the sample 1. As discussed herein, the mass of the sample 1 may be used in combination with a measurement of volume to determine the density of the sample. Alternatively, the weight of the sample may be measured prior to placing the sample in the apparatus 32. The support assembly 30 and sample 1 are placed on movable platform 7, which rests on wheels 7a, to allow the scale and the sample to be moved in and out of the container 3.

A DMT 8 is held in place by an upper support 34, which includes a DMT support 10 and a first and second linear motion mechanism 9 and 13, respectively. In the embodiment shown, the DMT 8 is a charge coupled device (CCD) based laser displacement transducer. Other DMTs known to those of ordinary skill in the art may be interchanged with a CCD based laser displacement transducer. The motion mechanisms 9 and 13 are secured by a translator mounting base 16 and a screw platform mounting 20.

The first linear motion mechanism 9 is controlled by motor assembly 12. As depicted in FIG. 2b first linear motion mechanism 9 moves the DMT support 10a from right to left. DMT support 10a holds the DMT 8 and is attached to a first threaded rod 9a such that when the first threaded rod 9a turns, the DMT 8 and the DMT support 10a move from right to left. First linear motion mechanism 9 is attached to a second linear motion assembly 13 through a support 19. Motion perpendicular to the threaded rod 9a is accomplished by the second linear motion mechanism 13 attached to a slide assembly 18. The second linear motion mechanism 13 includes a threaded rod 13a that is configured such that when the threaded rod 13a turns, the DMT 8 and DMT support 10a move perpendicular to threaded rod 9a (that is, right to left as depicted in FIG. 2a). The motion mechanisms 9 and 13 may be connected to a controller 15 by connections 17 through the DMT signal connector 14. Because both parallel and perpendicular motion in a horizontal plane relative to the sample is provided, the entire top surface 42 of sample 1 may be measured. Although the motion mechanisms 9, 13 shown are threaded rod assemblies, other motion and/or drive mechanisms known to those of ordinary skill in the art may be used. For example, the DMT support 10 may be moved on a track with various drive mechanisms such as hydraulic, pneumatic, piston mechanisms or slide mechanisms controlled by pulleys and filaments. A motion mechanism (not shown) configured to move the sample 1 with respect to the DMT 8 may be substituted for or used to supplement the motion mechanisms 9, 13. For example, a motion mechanism may be connected to the scale 6 or support base 4 for moving the sample 1 in any direction, for example, linearly, vertically, horizontally, angularly, circularly or rotationally.

FIG. 2a shows the detail of the support clamp assembly 5. Sample clamps 5a, 5a′ hold and clamp the sample about its diameter by allowing at least one of the clamps to be moveable in a linear directions. Clamp 5a is attached to shaft 5g by retaining ring 5b, guide rods 5c are attached to clamp 5a and inserted into insert 5e. The clamp 5a, retaining ring 5b, guide rods 5c and insert 5e are rotatable around the axis of shaft 5g. Shaft 5g is attached to a micrometer 5d in order to accurately move clamp 5a and to measure the diameter of sample 1. Clamp 5a′ is attached to shaft 5i with retaining ring 5h. Clamp 5a and location block 51 are configured to rotate around shaft 5i. After a rotation of about 180 degrees, the locators 5k in location block 51 are configured to lock into place at block 5j. Thus, the sample measurements may be made from a first top surface 42 of the sample and then rotated 180 degrees such that measurements may be made from the second bottom surface 44 of the sample.

With reference to FIG. 2a, the motion mechanism 13 includes a motor 11, a motor retaining screw 11a and a motor screw coupling 11b. The threaded rod 13 is secured with a screw retaining ring 13b and a screw platform mounting 13c. The motion mechanism 9 in FIG. 2b includes a motor 12 with a motor retaining screw 12a and a motor screw coupling 12b.

The distance from the DMT 8 and the centerline of the of the sample clamp S may be measured, for example, with the DMT 8 when the sample 1 is removed. The DMT 8 measures the displacement from the DMT 8 to the surface of the sample 1 as distance D1ᵢ at any particular location (i). The thickness at a location T1ᵢ may be calculated by subtracting D1ᵢ from S.

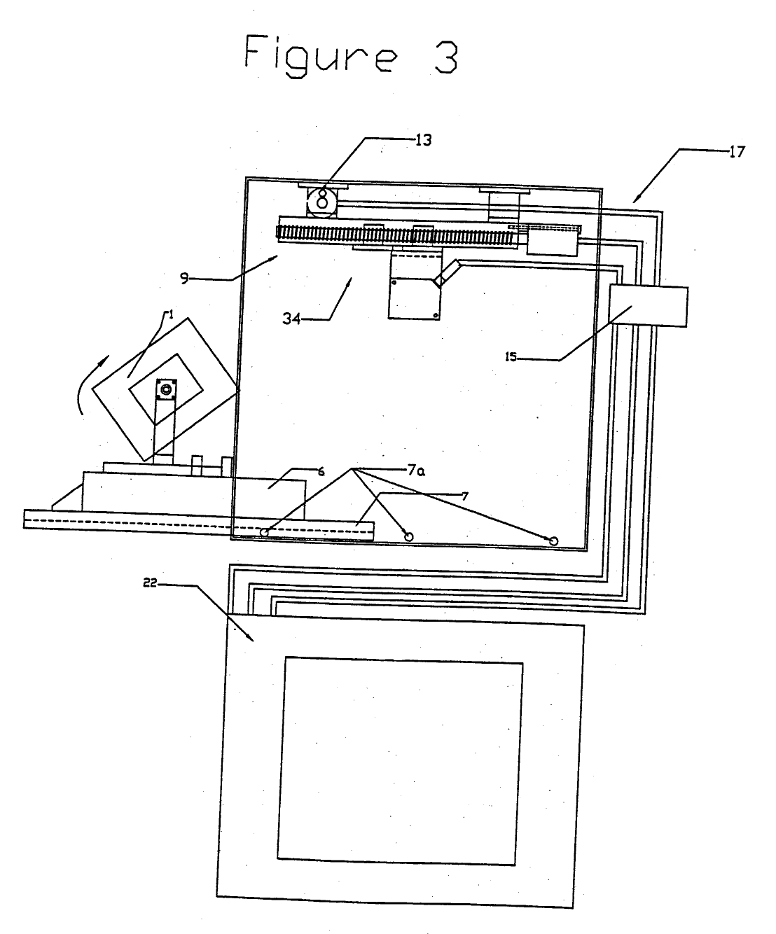

After measurements of the height of the sample from its centerline are made on both sides of the sample at a plurality of i locations, the average thickness of the sample may be calculated, for example, using the equations above. Specifically, the average thickness (T) and volume may be calculated using Equations 3a-3d below using the following parameters.

$$\begin{matrix}\overline{T} 1 = \frac{1}{N} {\sum }_{i = 1}^{N} ( S - D 1 , i ) & ( 3 a ) \\ \overline{T} 2 = \frac{1}{N} {\sum }_{i = 1}^{N} ( S - D 2 , i ) & \text{(3b)} \\ T = \overline{T} 1 + \overline{T} 2 & \text{(3c)} \\ V = π {r}^{2} T & \text{(3d)}\end{matrix}$$

where T is the average thickness of the sample 1, V is the volume, r is the radius of a cross section of the sample (or one half of the diameter D), \overline{T}1 is the average thickness from a desired midsection point to the first top surface 42, D1, i is depicted in FIG. 2b and measures the height distances from the DMT 8 to the first top surface 42, \overline{T}2 is the average thickness from a desired midsection point to the second bottom surface 44, and D2,j is the measurement of the distance from the DMT 8 to the second opposing bottom surface 44 of the sample 1. In the example shown, the sample 1 is rotated 180 degrees in order for the DMT 8 to measure the bottom surface 44, as depicted in FIG. 3.

The diameter as measured by the calipers and the average thickness calculated above may be used in Equation 2 to calculate the volume. The density (ρ) may be calculated using the following formula.

$${ρ}_{c} = \frac{{m}_{c}}{π {r}^{2} T} \qquad ( 4 )$$

where m_{c} is the mass of the sample 1 (FIG. 1) as measured by the scale 6, ρ_{c} is the density of the sample 1 and r is the radius (one half of the diameter D). Thus, an apparatus according to the invention may provide the information necessary to calculate the density of an object 1) inputting into the computer the diameter or measuring the diameter, for example, with calipers, 2) measuring the mass of the object with a scale, and 3) measuring a plurality of point positions on the external surface with a DMT.

FIG. 3 is a side view of the apparatus 32 shown in FIG. 2 such that the sample 1 may be pulled out and rotated. The rotation of the sample 1 may be used to make subsequent measurements. An apparatus 32 is shown with the sample 1 having been removed from the apparatus 32 through the motion of movable platform 7 on wheels 7a. The linear motion mechanisms 9 and 13 may be controlled by a controller 15 by connectors 17. A user may interact with the controller using a computer system 22. As will be appreciated by those of skill in the art, the computer system may include any of the following features for making calculations, interacting with a user, and other computer program operations: a processor, which may be any processor such as those commercially available from Intel Corporation, Santa Clara, Calif. or Advanced Micron Devices, Inc., Sunnyvale, Calif.; an operating system, which may be any operating system suitable for use with a data processing system, such as OS/2, AIX, OS/390 or System390 from International Business Machines Corporation, Armonk, N.Y., Windows CE, Windows NT, Windows95, Windows98 or Windows2000 from Microsoft Corporation, Redmond, Wash., Unix or Linux or FreeBSD, Palm OS from Palm, Inc., Mac OS from Apple Computer, or proprietary operating systems; various application programs; input/output “I/O” device drivers, which typically include software routines accessed through the operating system by the application programs to communicate with devices such as I/O data port(s), data storage and certain memory components. The application programs may include an application program for reading various dimension measurements from the controller 15 and the motion mechanisms 9, 13 and calculating the resulting volume.

Thus, the controller 15 may connect the DMT 8, the micrometer 5d, and the scale 6 to the computer system 22. As would be understood by one of ordinary skill in the art, the dimensional measurements from the DMT 8 and the micrometer 5d and the weight measurement from scale 6 may be recorded by storage and memory components in the computer system 22. A processor may calculate the volume and/or density of the sample 1 using known data processing techniques. A user may interact with the computer system 22 using known techniques, for example, to request specific calculations or change the parameters with which the apparatus 32 operates such as the number of dimensional measurements made, the units of measurements and the like.

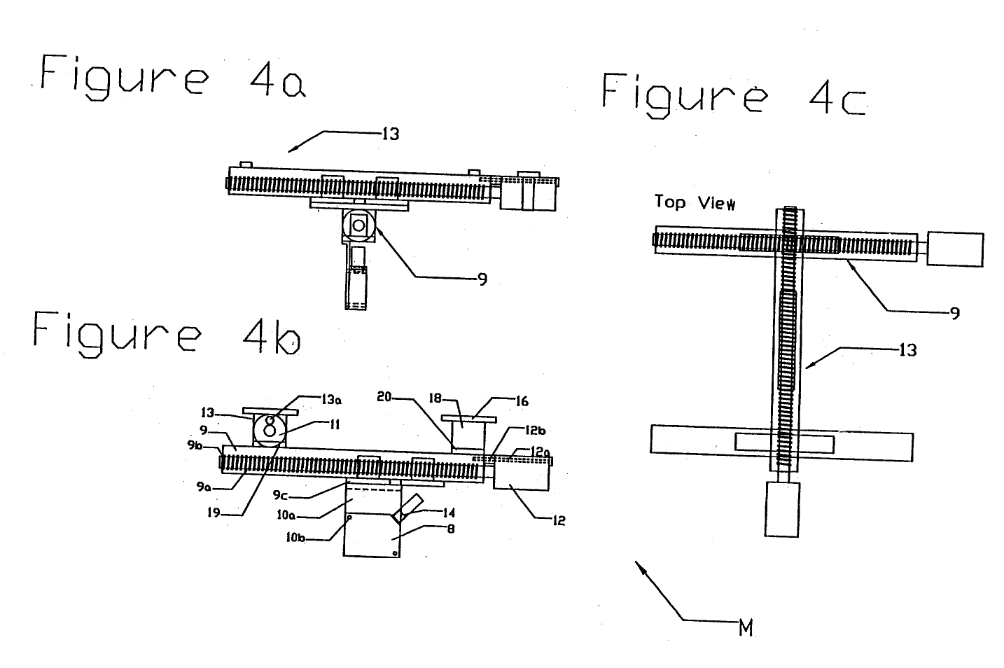

FIG. 4a shows a side view of linear motion mechanism 13. FIG. 4b depicts a side view of linear motion mechanism 9. A top view of linear motion mechanisms 9, 13 is shown in FIG. 4c.

FIG. 4a is a front side view of a pair of linear motion mechanisms. Specifically, a side view of linear motion mechanism 13 is shown perpendicular to linear motion mechanism 9. FIG. 4b is a right side view of the pair of linear motion mechanisms shown in FIG. 4a. FIG. 4b shows a side view of linear motion mechanism 9 perpendicular to linear motion mechanism 13. FIG. 4c is a top view the device shown in FIG. 4a, which depicts linear motion mechanisms 9, 13 in perpendicular relationship to each other.

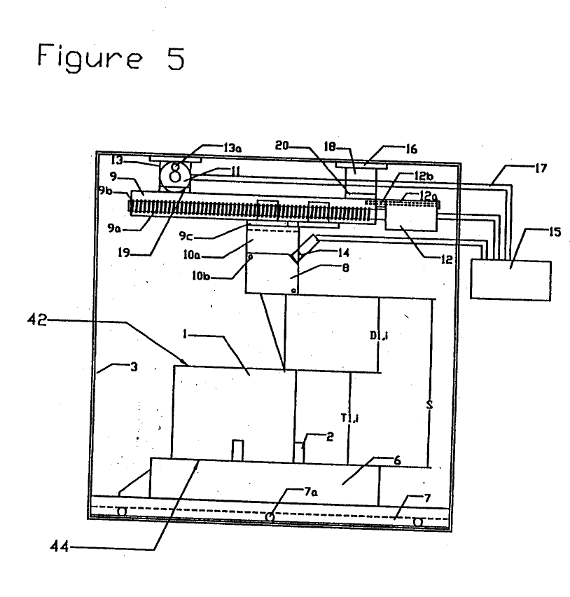

FIG. 5 is a side view of an alternative embodiment. The sample 1 is placed on a scale 6 for support. To obtain the height of the sample 1, the distance from the surface of the sample 1 to the DMT 8 (distance D₁ᵢ) as measured by the DMT 8 is subtracted from the distance from the top surface 42 of the scale 6 to the DMT 8 (distance S). The sample 1 may be rotated 180 degrees such that the opposing side (bottom surface 44) of the sample 1 may be measured. The thickness of the sample may be calculated from the average height of the two opposing surfaces: top surface 42 and bottom surface 44. Such a calculation requires that the sample 1 have a known diameter to calculate the volume using, for example, Equation 2.

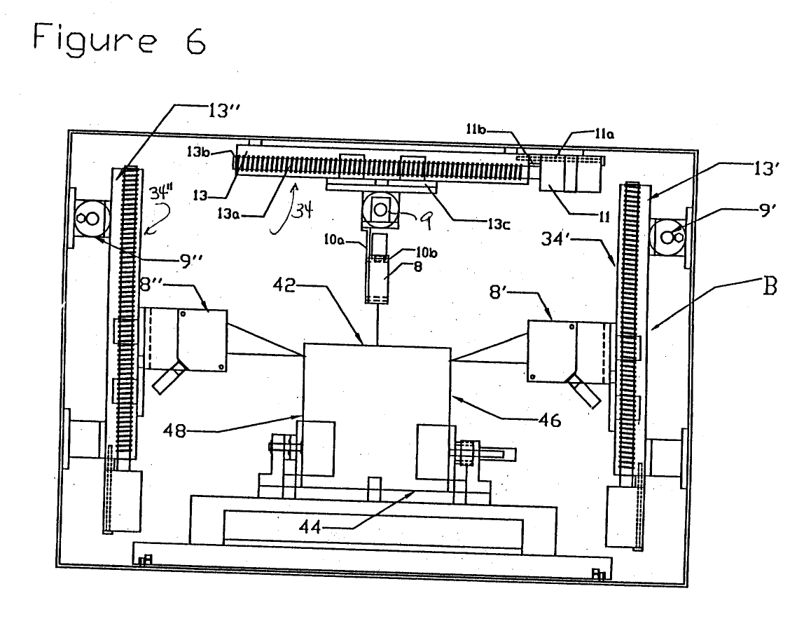

FIG. 6 is a side view of yet an additional embodiment of a device. The embodiment depicted in FIG. 6 provides for measurements to be made from three side surfaces 42, 46, 48 of the sample 1. Upper support 34 together with linear motion mechanisms 9, 13 make position point measurements on a first top surface 42 of sample 1 with DMT 8. A first side support 34′ includes linear motion mechanisms 9′, 13′ for controlling the motion of DMT 8′ to make position point measurements of a second right side surface 46 of sample 1. Position point measurements of a third left side surface 48 of sample 1 may be made by DMT 8″, which is held and motion controlled by a second side support 34″ and linear motion controllers 9″, 13″.

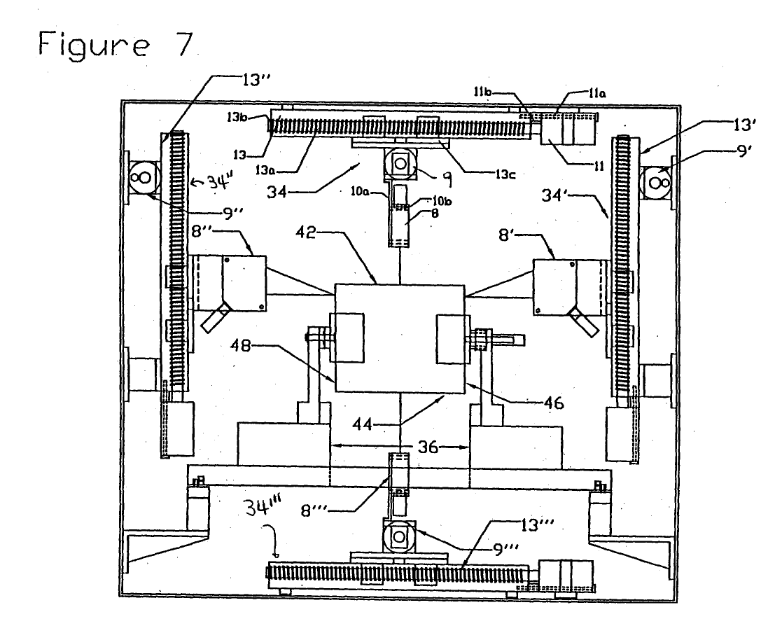

FIG. 7 is a side view of still further embodiments. In addition to the three supports 34, 34′, 34″, three sets of linear motion mechanisms 9, 9′, 9″, 13, 13′, 13″, and three DMTs 8, 8′, 8″, the apparatus depicted in FIG. 7 includes a bottom support 34′″ having a set of linear motion mechanisms 9′″, 13′″, and a DMT 8′″ for measuring the fourth bottom surface 44 of sample 1. The scale 6 includes a gap 36 positioned so that a substantially unobstructed line of sight is provided extending from DMT 8′″ to the sample 1 such that DMT 8′″ may measure the fourth bottom surface 44 of the sample 1.

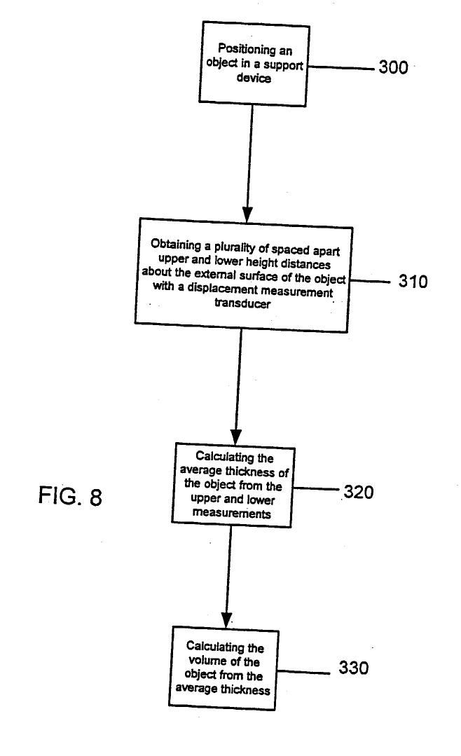

FIG. 8 illustrates the flow of embodiments of the method. At Block 300 the object is placed in a support device, such as the support devices described herein. The support device may include calipers or other mechanisms known to those of skill in the art for measuring the diameter or width of the object. At Block 310, a plurality of spaced apart upper and lower height distances about the external surface of the object are obtained using a DMT. The average thickness is then calculated from the upper and lower measurements at Block 320, for example, using Equation 1 or Equation 3. The volume may be calculated at Block 330, for example using the average thickness and an appropriate volume equation, such as Equation 2. Additional steps for various measurements include weighing the object and calculating the volume, for example, using Equation 4.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-fiction clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. An apparatus for measuring at least one predetermined characteristic of an object comprising:
a support assembly for holding an irregularly shaped three dimensional object in a desired position;
a displacement measurement transducer disposed a predetermined distance away from said support assembly, wherein said displacement measurement transducer is configured to measure a plurality of different external profile point positions on the object; and
means for moving at least one of said support assembly or said displacement measurement transducer, whereby said displacement transducer measures a plurality of external point positions on the object.

2. The apparatus of claim 1, further comprising a scale configured for measuring the weight of the object.

3. The apparatus of claim 1, wherein said means for moving comprises at least one linear motion mechanism connected to said displacement measurement transducer for moving said displacement measurement transducer with respect to the object.

4. The apparatus of claim 3, wherein said linear motion mechanism comprises a threaded rod.

5. The apparatus of claim 1, wherein said means for moving comprises first and second linear motion mechanisms connected to said displacement measurement transducer, wherein said first and second linear motion mechanisms are positioned to move said displacement measurement transducer along two perpendicular axis in a common plane.

6. The apparatus of claim 1, wherein said means for moving comprises a motion mechanism connected to said support assembly for moving said support assembly in at least one of a linear direction and a rotational direction.

7. The apparatus of claim 1, wherein said displacement measurement transducer comprises a laser transducer.

8. The apparatus of claim 1, wherein said support assembly further comprises one or more clamps for holding the object.

9. The apparatus of claim 1, wherein said support assembly further comprises a first and second clamp for holding the object and a means for measuring the distance between said first and second clamp whereby the width of the object is measured.

10. The apparatus of claim 9, wherein said means for measuring distance comprises a micrometer.

11. The apparatus of claim 1, wherein said support assembly further comprises calipers for measuring the width of the object.

12. The apparatus of claim 1, further comprising a computer processor operatively connected to said displacement measurement transducer for recording distance measurements corresponding to point positions on the object and calculating the volume of the object.

13. The apparatus of claim 2, wherein said computer processor includes program code for calculating the density of the object.

14. The apparatus of claim 12, wherein the plurality of different external profile point positions comprises a plurality of spaced apart upper and lower height measurements, said apparatus further comprising program code for calculating the average thickness of the object using the equation:
$$T = \frac{1}{N} {\sum }_{i = 1}^{N} {h}_{ia} + \frac{1}{{N}^{′}} {\sum }_{j = 1}^{{N}^{′}} {h}_{jb}$$
where T is the average thickness, N is the number of measurements, and hᵢₐ and h_{jb} are one of the plurality of spaced apart upper and lower height distances.

15. The apparatus of claim 14, wherein the object has a substantially circular cross section, and further comprising program code for calculating the volume of the object performed using the equation:
$$V = {π ( \frac{1}{2} D )}^{2} T$$
where V is the volume, D is the diameter of the circular cross section, and T is the average thickness.

16. The apparatus of claim 15, further comprising program code for calculating the density of the object using the equation:
$$ρ = \frac{m}{{π ( \frac{1}{2} D )}^{2} T}$$
where m is the mass of the object.

17. A method for measuring at least one predetermined characteristic of an object comprising:
positioning a three dimensional object having a coarse external surface in a support device;
obtaining a plurality of spaced apart upper and lower height distances about the external surface of the object;
calculating the average thickness of the object from the plurality of spaced apart upper and lower height distances; and
calculating the volume of the object from the average thickness.

18. The method of claim 17, wherein calculating the average thickness of the object is performed using the equation:
$$T = \frac{1}{N} {\sum }_{i = 1}^{N} {h}_{ia} + \frac{1}{{N}^{′}} {\sum }_{j = 1}^{{N}^{′}} {h}_{jb}$$
where T is the average thickness, N is the number of upper measurements, N′ is the number of lower measurements, and hᵢₐ is one of the plurality of upper measurements and h_{jb} is one of the plurality of spaced apart lower height distances.

19. The method of claim 18, wherein the object has a circular cross section, and wherein calculating the volume of the object is performed using the equation:
$$V = {π ( \frac{1}{2} D )}^{2} T$$
where V is the volume, D is the diameter of the circular cross section, and T is the average thickness.

20. The method of claim 19, further comprising:
measuring the mass of the object; and
calculating the density of the object.

21. The method of claim 20, wherein the calculation of the density is performed using the equation:
$$ρ = \frac{m}{{π ( \frac{1}{2} D )}^{2} T}$$
where m is the mass of the object.

22. The method of claim 17, further comprising automatedly obtaining the plurality of spaced apart upper and lower height distances with a displacement measurement transducer.

23. A method for determining the density of an object, comprising:
positioning a three dimensional object having a coarse external surface in a support device;
automatically obtaining a plurality of spaced apart dimensional measurements about the external surface of the object;
determining the volume of the object from the dimensional measurements;
automatically obtaining a measurement of the mass of the object; and
calculating the density of the object using the ratio of mass to volume.

24. The method of claim 23, wherein the object is a compacted bituminous mixture.

25. A method for determining the volume of an object, comprising:
positioning a three dimensional object having a coarse external surface in a support device;
automatically obtaining a plurality of spaced apart dimensional measurements about the external surface of the object; and
determining the volume of the object from the dimensional measurements.

26. The method of claim 25, wherein the object is a compacted bituminous mixture.

27. A method for determining selected dimensions of an object, comprising:
positioning a three dimensional compacted bituminous object having a coarse external surface in a support device; and
automatically obtaining a plurality of spaced apart dimensional measurements about the external surface of the object using a displacement measurement transducer.
